(19) United States
(12) Patent Application Publication
(10) Pub. No.: US 2017/0218863 A1
(43) Pub. Date: Aug. 3, 2017

(54) METHOD AND DEVICE TO CONTROL EXHAUST GAS RECIRCULATION

(71) Applicant: Cummins Inc., Columbus, IN (US)

(72) Inventors: Samuel C. Geckler, Columbus, IN (US); David Stroh, Columbus, IN (US); Steven J. Kolhouse, Columbus, IN (US); Anthony Kyle Perfetto, Columbus, IN (US)

(21) Appl. No.: 15/481,052

(22) Filed: Apr. 6, 2017

Related U.S. Application Data
(63) Continuation-in-part of application No. 14/506,223, filed on Oct. 3, 2014.

(51) Int. Cl. F02D 41/00; F02P 5/15; F02D 37/02; F02D 41/26; F02D 41/14

(52) U.S. Cl. CPC F02D 41/0057; F02D 41/26; F02D 41/0087; F02D 41/1454; F02D 37/02; F02P 5/15

(57) ABSTRACT

A method, a combustion engine controller, and a combustion engine incorporating the controller to implement the method are provided. The method includes determining a first dedicated exhaust gas recirculation (D-EGR) cylinder parameter value of a first D-EGR cylinder parameter associated with a first D-EGR cylinder of the combustion engine; and regenerating the first D-EGR cylinder responsive to the first D-EGR cylinder parameter value satisfying a threshold indicative of a carbon build-up level.

### CROSS-REFERENCE TO RELATED APPLICATIONS

The present application is a continuation-in-part of and claims priority from U.S. patent application Ser. No. 14/506,223, titled “VARIABLE IGNITION ENERGY MANAGEMENT” filed on Oct. 3, 2014, said priority application being incorporated by reference herein in its entirety.

### FIELD OF THE INVENTION

The present invention relates generally to the field of exhaust gas recirculation for combustion engines. More particularly, the present invention relates to methods and devices to control operation of combustion cylinders for dedicated exhaust gas recirculation.

### BACKGROUND

Combustion engines include a plurality of cylinders. Ignition timing and fuel injection may be controlled equally or differently for each cylinder, But variations in manufacturing and use result in combustion variability between cylinders. Ignition timing may be varied to balance torque produced by the cylinders. The air/fuel ratio may also be controlled by controlling fuel injection in the combustion cylinders.

Combustion engines may include systems to receive and then recirculate exhaust gas to reduce emissions. Some cylinders may be dedicated to exhaust gas recirculation (EGR) while the exhaust gas from other cylinders, the non-dedicated cylinders, is not recirculated. EGR works by recirculating a portion of the exhaust gases back to the cylinders. The recirculated gases mix with a fresh gas charge and dilute the oxygen in the fresh gas charge while providing gases inert to combustion to act as absorbents of combustion heat to reduce peak in-cylinder temperatures. The air/fuel ratio (“AFR”) and EGR fraction or ratio of the combustion engine or particular cylinders may be controlled to achieve desirable combustion and emission objectives.

Dedicated EGR cylinders may form carbon in the combustion cylinders walls, the piston, or the valves due to the conditions under which they are operated. Carbon deposits may build in less than 1,000 miles if the conditions are correct. Numerous cold starts and warm-up cycles, and excessive idling are some of the conditions that cause rapid carbon build-up. Carbon build-up reduces efficiency and creates additional operating problems. In view of the complexity of combustion engines with EGR systems, it would be desirable to provide control mechanisms to overcome at least the foregoing limitations in combustion engines.

### SUMMARY OF DISCLOSED EMBODIMENTS

Embodiments of the present invention provide a method to control a combustion engine including dedicated EGR cylinders, an engine controller including control logic structured to implement the method, and a combustion engine including the engine controller and performing the method. In various embodiments described below, the operating conditions of dedicated EGR cylinders are controlled to reduce an amount of built-up carbon by regenerating the dedicated EGR cylinders. Regeneration may be performed in one dedicated EGR cylinder while the operating conditions of another dedicated EGR cylinder are adjusted to compensate for such regeneration.

In some embodiments, a method of operating a combustion engine comprises determining a first dedicated exhaust gas recirculation (D-EGR) cylinder parameter value of a first D-EGR cylinder parameter associated with a first D-EGR cylinder of the combustion engine; and regenerating the first D-EGR cylinder responsive to the first D-EGR cylinder parameter value indicative of a carbon build-up level satisfying a threshold. The threshold may be correlated to an undesirable amount of carbon build-up.

In some embodiments, a method of operating a combustion engine comprises determining a first dedicated exhaust gas recirculation (D-EGR) cylinder parameter value of a first D-EGR cylinder parameter associated with a first D-EGR cylinder of the combustion engine; determining that a carbon build-up level in the first D-EGR cylinder is excessive in response to the first D-EGR cylinder parameter value satisfying a threshold or that the carbon build-up level in the first D-EGR cylinder is not excessive if the first D-EGR cylinder parameter value not satisfying the threshold; and responsive to said determining that the first D-EGR cylinder parameter value satisfies said threshold, regenerating the first D-EGR cylinder to reduce the carbon build-up level in the first D-EGR cylinder.

Advantageously, cylinder regeneration may increase the efficiency of the combustion cylinder and reduce its emissions. Further, operating different EGR cylinders in different ways enables such regeneration to occur on a cylinder by cylinder basis while maintaining desired EGR parameters of the combustion engine. Such parameters may include the EGR fraction or ratio and the pressure or temperature of the gases generated by the dedicated EGR cylinders.

In various embodiments, a combustion engine controller comprises control logic; input contacts electrically coupled to the control logic and configured to receive operating condition values representative of operating conditions of the combustion engine; and output contacts electrically coupled to the control logic and configured to transmit control signals operable to control operation of the combustion engine, wherein the control logic is structured to determine a first dedicated exhaust gas recirculation (D-EGR) cylinder parameter value of a first D-EGR cylinder parameter associated with a first D-EGR cylinder of the combustion engine; and responsive to the first D-EGR cylinder parameter value satisfying a threshold, transmit the control signals via the output contacts to cause regeneration of the first D-EGR cylinder.

In various embodiments, a combustion engine comprises: fuel injectors; combustion chambers including a first D-EGR combustion chamber including a first D-EGR cylinder; sensors; and a combustion engine controller comprising control logic; input contacts electrically coupled to the control logic and configured to receive operating condition values representative of operating conditions of the combustion engine; and output contacts electrically coupled to the control logic and configured to transmit control signals operable to control operation of the combustion engine, wherein the control logic is structured to determine a first D-EGR cylinder parameter value of a first D-EGR cylinder parameter associated with the first D-EGR cylinder of the combustion engine; and responsive to the first D-EGR cylinder parameter value satisfying a threshold, transmit the control signals via the output contacts to cause regeneration of the first D-EGR cylinder. The combustion engine controller receives data from the sensors and transmits the control signals to control the fuel injectors to regenerate the first D-EGR cylinder.

In various embodiments described below, regeneration of a dedicated EGR cylinder is responsive to determining that the carbon build-up is excessive, as evidenced by a dedicated EGR cylinder parameter value satisfying a threshold. The threshold may be satisfied in some cases when it is met or exceeded, for example when increases in the dedicated EGR cylinder parameter value are proportional to increases in carbon build-up. In other cases, the threshold may be satisfied when the dedicated EGR cylinder parameter value is less than the threshold, for example when decreases in the dedicated EGR cylinder parameter value are proportional to increases in carbon build-up.

Additional features, advantages, and embodiments of the present disclosure may be set forth from consideration of the following detailed description, figures, and claims. Moreover, it is to be understood that both the foregoing summary of the present disclosure and the following detailed description are exemplary and intended to provide further explanation without further limiting the scope of the present disclosure claimed.

### BRIEF DESCRIPTION OF THE FIGURES

The accompanying figures illustrate embodiments of the present disclosure and, together with the detailed description, serve to explain the principles of the invention. In the figures, like reference characters generally refer to like features (e.g., functionally similar and/or structurally similar elements).

FIG. 1 is a schematic diagram of an embodiment of a variable energy management system.

FIG. 2 is a schematic diagram of an embodiment of an engine management module coupled to an ignition management module.

FIG. 3 is a block diagram of another embodiment of an engine management module.

FIG. 4 is a flowchart of an embodiment of a method for managing ignition in a combustion engine,

FIG. 5 is a block diagram of an embodiment depicting EGR functionality of an engine controller.

### DETAILED DESCRIPTION OF EMBODIMENTS OF THE DISCLOSURE

In the following detailed description, reference is made to the accompanying figures, which form a part hereof. The illustrative embodiments described herein are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be performed, arranged, substituted, combined, and designed in a wide variety of different configurations.

Some of the embodiments described below relate to methods and devices for control of dedicated EGR cylinders of combustion engines. The combustion engines may combust diesel fuel or gasoline, for example, and may comprise spark plugs or lack spark plugs. In various embodiments, the operating conditions of dedicated EGR cylinders are controlled to reduce the amount of built-up carbon, e.g. to regenerate, the dedicated EGR cylinders. Regeneration may be performed in one dedicated EGR cylinder while the operating conditions of another dedicated EGR cylinder are adjusted to compensate for such regeneration. In some embodiments, regeneration of a dedicated EGR cylinder is responsive to determining that the dedicated EGR cylinder parameter value satisfies a threshold. The threshold may be satisfied in some cases when it is met or exceeded, for example when increases in the dedicated EGR cylinder parameter value are proportional to increases in carbon build-up. In other cases, the threshold may be satisfied when the dedicated EGR cylinder parameter value is less than the threshold, for example when decreases in the dedicated EGR cylinder parameter value are proportional to increases in carbon build-up.

Some of the embodiments described below relate to methods and devices for ignition energy management for engines. In such embodiments, ignition energy is managed by adjusting particular ignition energy characteristics, such as an amount of ignition aid energy, for one or more cylinders of a combustion engine based on various engine operating conditions. By way of illustration, the ignition energy characteristics may further include a total energy amount (or cumulative energy over the spark duration), timing, amplitude, duration, waveform shape, and number of energy pulses (multi-strike). The waveform shape may also represent strike duration and multi-strike ignition events. By controlling ignition energy characteristics according to a cylinder-by-cylinder approach, ignition energy may be optimized for each cylinder, which may result in longer ignition aid plug duration. At least some embodiments may realize significant engine performance improvements. Ignition energy characteristics may also be configured to aid in the regeneration of a D-EGR cylinder.

In some embodiments, the characteristics to be controlled on an individual cylinder basis may relate to EGR techniques used in a vehicle. For example, in some embodiments, ignition energy characteristics may be modified based on an estimated EGR fraction per cylinder.

In a combustion engine having a plurality of cylinders, a determination of which cylinder is an igniting cylinder may be made so as to permit controlling of individual ignition aid plug timing for each of the plurality of cylinders. Controlling timing may be undertaken to enhance cylinder balancing, for example. Controlling timing differs from directly controlling the amount of energy associated with ignition of individual cylinders, however. Controlling the amount of energy directly—and not just the timing—can extend the lifetime of ignition aid plugs, as noted above.

Some embodiments allow for individualized control of the ignition energy characteristics for a plurality of cylinders. Other embodiments allow for a common adjustment of ignition energy for non-dedicated EGR cylinders. In both cases at least one ignition energy characteristic is adjusted in response to at least one engine operating condition. The engine operating conditions may include, but are not limited to, EGR fraction, EGR flow rate, EGR mapping, charge-air flow rate, lambda value corresponding to an air/fuel ratio, in-cylinder pressure, in-cylinder temperature, a knock detection metric, a misfire detection metric, a cylinder balancing determination, intake air temperature, an EGR quality metric, a gas quality metric, mass air flow rate, engine load, intake manifold temperature, coolant temperature, engine speed, a dual fuel mode, a substitution rate, whether the fuel injectors are configured as direct injectors or port injectors, ethanol boosting (dual fuel) for the direct injector and port injector configurations, water injection, a regeneration mode, a torque control, component age, e.g. ignition aid age and fuel injector age, ignition aid plug resistance, and transient characteristics such as time elapsed between events such as maintenance and regeneration events. The aforementioned operating conditions may be determined based on any combination of sensed values and/or estimated values. The ignition energy characteristics may be adjusted to control outputs including cylinder pressure, exhaust temperature, exhaust manifold pressure, exhaust oxygen content, combustion knock, misfires, cylinder balancing, and engine vibration levels.

As described below, a regeneration event is caused by raising the temperature of a D-EGR cylinder above a temperature sufficiently high to burn off carbon deposits, which may be referred to as the regeneration temperature. Under certain circumstances an engine may naturally raise the temperature of a D-EGR cylinder. The highest temperatures will be reached naturally when the engine is operating at high load with a lean AFR. On the other hand, lowest temperatures will be reached naturally when the engine is operating at low load with a rich AFR. Accordingly, the regeneration event may be a natural regeneration event, meaning that it is a result of the load or other operating requirements on the engine, and the regeneration event may also be a build-up induced regeneration event, meaning that it is not a result of the load or other operating requirements on the engine but rather it is an event responsive to a first D-EGR cylinder parameter value satisfying a threshold indicative of a carbon build-up level. In some embodiments, the first D-EGR cylinder parameter value comprises a carbon build-up parameter based on elapsed time since the regeneration event, which may be either the natural or build-up induced regeneration event. The elapsed time is intended to capture carbon build-up data since the regeneration event, and since carbon builds up under certain conditions, the elapsed time might include only the time (since the regeneration event) during which those conditions that build carbon were present. In one example, the elapsed time is the time that elapses since a regeneration event but only while the fuel mixture is rich, which may be represented as the AFR or lambda being equal or less than a build-up threshold.

It should be understood that a non-dedicated EGR cylinder (“ND-EGR cylinder”) comprises a cylinder which is not dedicated to exhaust gas recirculation. The ND-EGR cylinder might not be coupled to the recirculation system and is therefore never able to contribute exhaust gases for recirculation, or might be selectively coupled to the recirculation system and therefore not be dedicated to recirculation of exhaust gases.

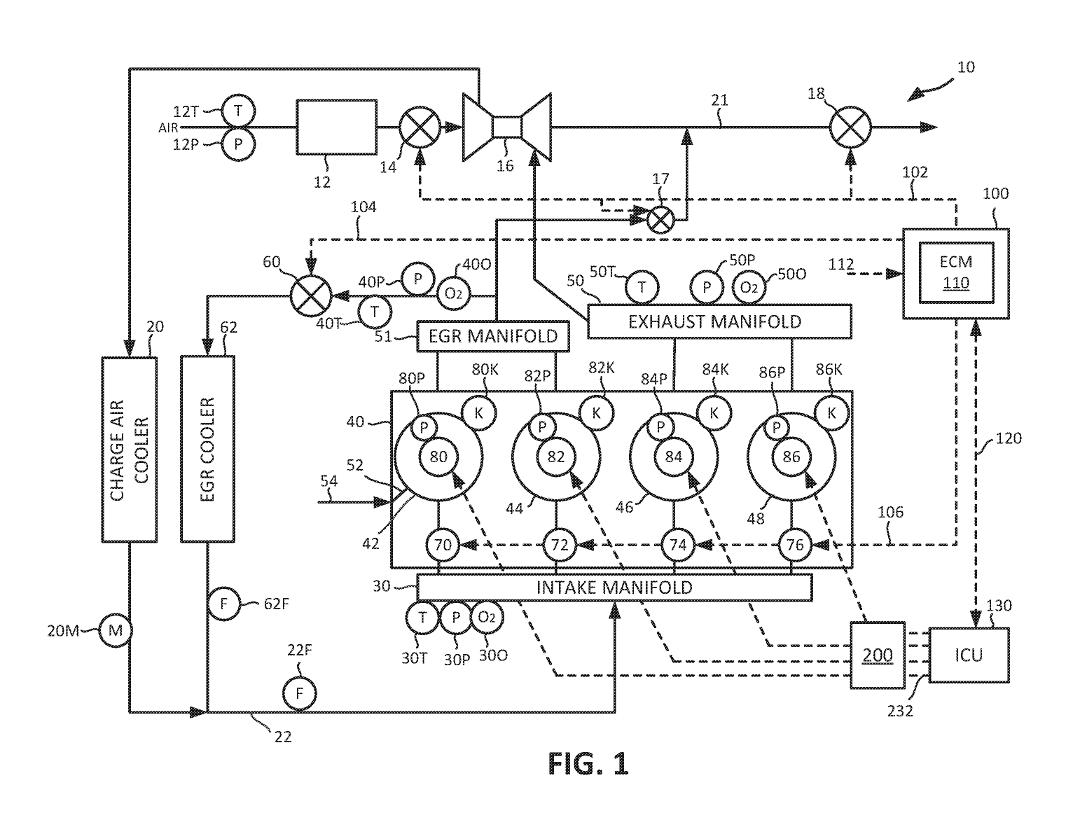

Referring now to FIG. 1, an embodiment of a combustion engine 10 is shown including an intake manifold 30, a block 40, and an exhaust manifold 50. In the present embodiment, combustion engine 10 comprises a processing subsystem 100 including an engine control module (ECU) 110 configured to manage ignition energy provided to ignition aid plugs 80, 82, 84, and 86 to aid in the ignition of fuel delivered by fuel injectors 70, 72, 74, and 76 to combustion cylinders 42, 44, 46, and 48, where the fuel mixes with air and is ignited. Exemplary ignition aid plugs 80, 82, 84, and 86 include spark-plugs and glow-plugs. Exemplary fuel injectors 70, 72, 74, and 76 include direct fuel injectors, which inject fuel directly into combustion cylinders 42, 44, 46, and 48, and port injectors, which spray fuel into intake ports fluidly connected to combustion cylinders 42, 44, 46, and 48. Control subsystem 100 may include other control modules such as a transmission system control module, an exhaust system control module, a fuel supply system control module, and others.

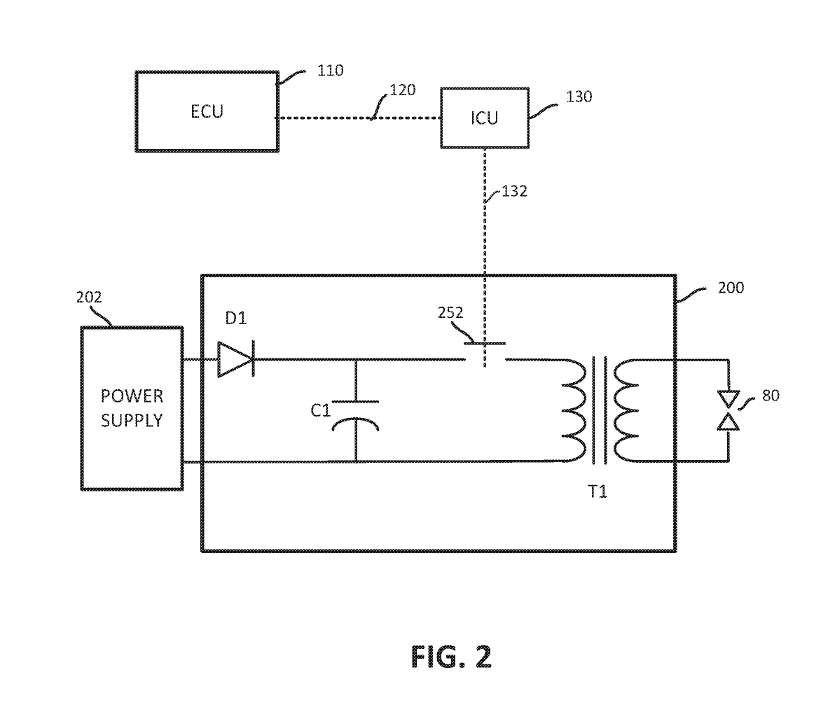

In certain embodiments, ECM 110 is structured to perform certain operations, such us controlling the ignition aid plugs of the combustion engine and/or the AFR, compression, EGR fraction, and other operating parameters of D-EGR cylinders to cause cylinder regeneration. ECM 110 determines operating conditions of engine 10 based on measured parameters and operating models. In some examples, based on the operating conditions and desired performance, ECM 110 transmits control signals to operate fuel injectors, EGR valves, dump valves, and other devices to increase the temperature of a D-EGR cylinder to cause its regeneration. In some examples, the control parameters comprise ignition energy control signals 120 sent to an ignition control unit 130, which delivers ignition energy to ignition aid plugs 80, 82, 84, and 86 based on the ignition energy control signals. Operation of ignition control unit 130 is described in additional detail with reference to FIG. 2.

ECM 110 may be referred to herein as a “controller” or “engine controller.” In certain embodiments, the controller forms a portion of a processing subsystem including one or more computing devices having non-transient computer readable storage media, processors or processing circuits, and communication hardware. The controller may be a single device or a distributed device, and the functions of the controller may be performed by hardware and/or by processing instructions stored on non-transient machine readable storage media. Example processors include an application specific integrated circuit (ASIC), a field programmable gate array (FPGA), a digital signal processor (DSP), and a microprocessor including firmware. Example non-transient computer readable storage media includes random access memory (RAM), read only memory (ROM), flash memory, hard disk storage, electronically erasable and programmable ROM (EEPROM), electronically programmable ROM (EPROM), magnetic disk storage, and any other medium which can be used to carry or store processing instructions and data structures and which can be accessed by a general purpose or special purpose computer or other processing device.

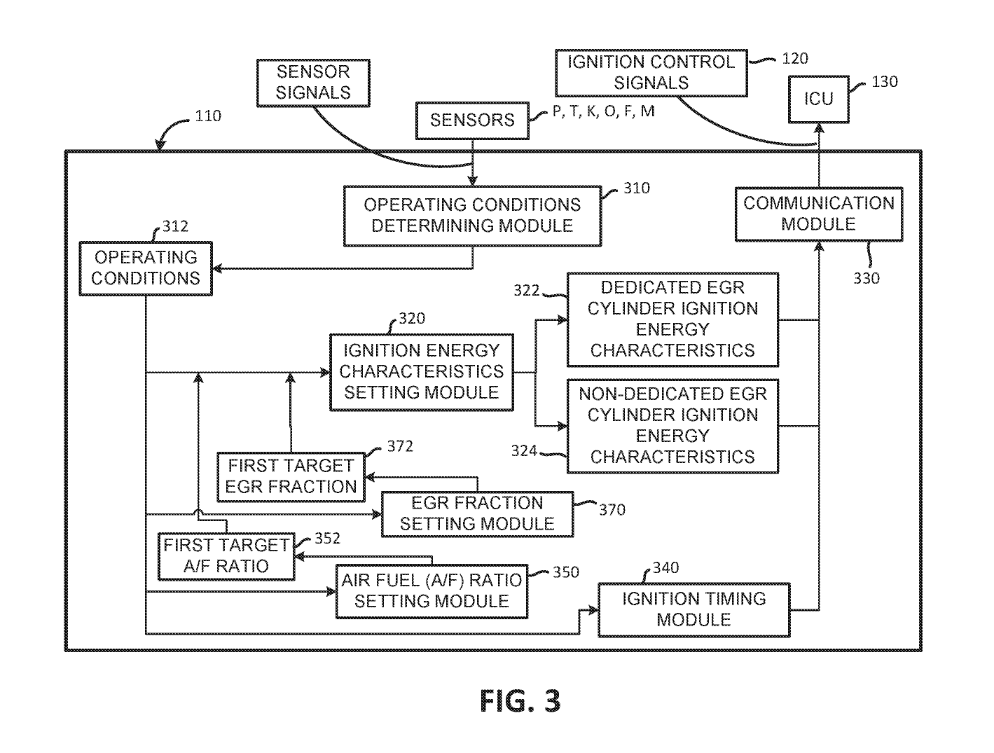

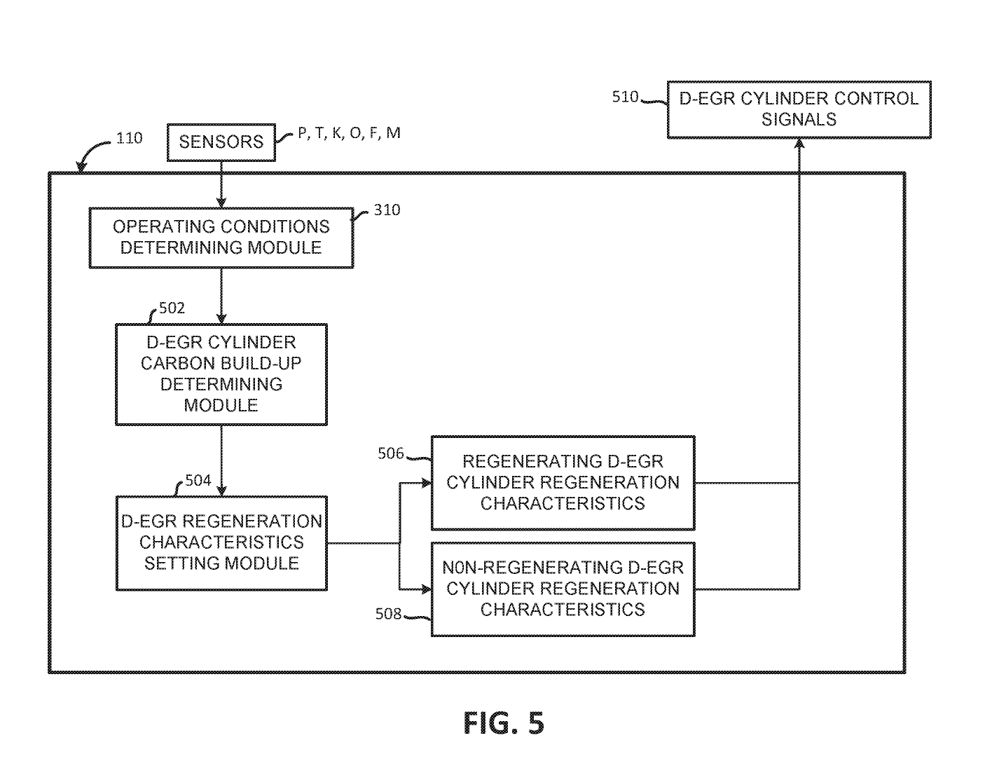

In certain embodiments, the controller includes one or more modules structured to functionally execute the operations of the controller. Example modules, some of which are described with reference to FIG. 3, include an operating conditions determining module, an ignition energy setting module, a communication module, and an ignition timing module. Additional modules are described with reference to FIG. 5. The description herein including modules emphasizes the structural independence of certain aspects of the controller, and illustrates one grouping of operations and responsibilities of the controller. Other groupings that execute similar overall operations are understood to be within the scope of the present application. Modules may be implemented in hardware and/or as processing instructions on a non-transient computer readable storage medium. Modules may be distributed across various hardware or computer based components. Example and non-limiting module implementation elements include sensors providing any value determined herein, sensors providing any value that is a precursor to a value determined herein, datalink and/or network hardware including communication chips, oscillating crystals, communication links, cables, twisted pair wiring, coaxial wiring, shielded wiring, transmitters, receivers, and/or transceivers, logic circuits, hard-wired logic circuits, reconfigurable logic circuits in a particular non-transient state configured according to the module specification, any actuator including at least an electrical, hydraulic, or pneumatic actuator, a solenoid, an operational amplifier integrated circuit, analog control elements (springs, filters, integrators, adders, dividers, gain elements), and/or digital control elements.

Certain operations described herein include operations to interpret and/or to determine one or more parameters. Interpreting or determining, as utilized herein, includes receiving values by any method known in the art, including at least receiving values from a datalink or network communication, receiving an electronic signal (e.g. a voltage, frequency, current, or pulse-width-modulation signal) indicative of the value, receiving a computer generated parameter indicative of the value, reading the value from a memory location on a non-transient machine readable storage medium, receiving the value as a run-time parameter by any means known in the art, and/or by receiving a value by which the interpreted parameter can be calculated, and/or by referencing a default value that is interpreted to be the parameter value.

Combustion engine 10 further comprises an exhaust system including exhaust manifold 50, which receives exhausted gases from ND-EGR cylinders 46 and 48, and an EGR valve 60, which receives exhausted gases from D-EGR cylinders 42 and 44, which may be referred to herein as the first and second D-EGR cylinders, respectively. EGR valve 60 may be controlled by ECM 110 via ECM valve control signals 104. In variations of the present embodiment, combustion engine 10 may comprise more or fewer dedicated EGR cylinders and additional or fewer non-dedicated EGR cylinders. Exhausted gases from the non-dedicated EGR cylinders drive an air-charger 16, also referred to as a turbocharger. Exhausted gases from the dedicated EGR cylinders flow through EGR valve 60 and an EGR cooler 62, where they are cooled, before they flow back into intake manifold 30. In the present arrangement, about 25% of the exhaust gases are recirculated through EGR cooler 62. Of course, a dedicated EGR cylinder may be larger (or smaller) than a non-dedicated EGR cylinder to increase (decrease) the percentage volume of exhaust gases for recirculation. Dedicated EGR cylinders may also have different bore size, stroke, and compression ratio, which differences may require different ignition aid energy tuning. The volume of gases may be controlled by EGR valve 62. In a variation of the present embodiment in which two of six combustion cylinders are dedicated EGR cylinders, about 33% of the exhaust gases may be recirculated. Since the dedicated EGR cylinders determine the recirculation gas volume, it is advantageous to control dedicated EGR cylinders differently than non-dedicated EGR cylinders. Dedicated EGR cylinders may receive a different air/fuel mixture than non-dedicated EGR cylinders. Consequently, it is advantageous to independently control the ignition energy of the ignition aid plugs of the dedicated and non-dedicated EGR cylinders to achieve a desired performance tailored to the characteristics of the cylinders, the combustion engine, the load coupled to the combustion engine, and the application in which the combustion engine is used.

Combustion engine 10 further comprises an air filter 12, an air input throttle 14 on one side of air-compressor 16, and an exhaust throttle 18 on the opposite side. ECM 110 transmits throttle control signals 102 to control air input throttle 14 and exhaust throttle 18, to control the volume and pressure of gases entering and leaving combustion engine 10. A piston cooling nozzle 52 may be provided to discharge a cooling fluid 54 flowing therethrough to cool a cylinder. Although one piston cooling nozzle 52 is shown, each cylinder may comprise a piston cooling nozzle 52. The flow of cooling fluid 54 may be controlled by ECM 110 and a suitable valve to compensate for increased heat generated during cylinder regeneration. A turbine bypass valve 17 fluidically couples an EGR exhaust manifold 51 to a conduit 21 located downstream of air-compressor 16. Turbine bypass valve 17 enables discharge of gases produced by regeneration of a D-EGR cylinder to the exhaust system to avoid recirculation of said gases and particulates therein through EGR cooler 62. Such discharging may also reduce the temperature of the gases flowing to EGR cooler 62 to compensate for increased heat generated during cylinder regeneration. Filtered air compressed by air-compressor 16 is cooled by a charge-air cooler 20, Cooled fresh air gases and cooled recirculated exhaust gases flow in a conduit 22 to intake manifold 30, from where the mixture of fresh gases and recirculated gases is provided to combustion cylinders 42, 44, 46, and 48.

ECM 110 determines a plurality of operating conditions of combustion engine 10 with sensor signals received via one or more signal links 108 from a plurality of sensors, or sensor modules, such as pressure, temperature, oxygen, flow, mass, knock, vibration and any other suitable sensors. In FIG. 1, temperature sensors are identified by the letter T following a number corresponding to the temperature of the part being sensed. Thus, temperature sensor 12T senses the temperature of air entering filter 12, temperature sensor 50T senses the temperature of exhaust manifold 50, and temperature sensor 30T senses the temperature of intake manifold 30. Other sensors are similarly identified. Altitude (pressure) sensor 12P senses the ambient pressure. Pressure and temperature sensors (not shown) may also be provided to sense the pressure and temperatures of charge-air cooler 20 and EGR cooler 62, Also shown are intake and exhaust manifold pressure sensors 30P and 50P, exhaust manifold oxygen sensor 50O, and dedicated EGR exhaust pressure sensor 40P, temperature sensor 40T, and oxygen sensor 40O. Exhaust manifold 50 temperature and oxygen parameters represent the temperature and oxygen of non-dedicated EGR cylinders, Additional sensors include charge-air cooler mass-flow sensor 20M, EGR cooler flow sensor 62F, and intake manifold intake flow sensor 22F. Pressure sensors (not shown) may also be provided to measure the pressure inside each fuel injector to control fuel injection. Pressure sensors 80P, 82P, 84P, and 86P are provided to measure in-cylinder pressures, and knock sensors 80K, 82K, 84K, and 86K are provided to measure knock in each cylinder. Knock sensors may sense vibration, noise, or any other variable indicative of cylinder knock. In some embodiments, knock sensors 80K, 82K, 84K, and 86K comprise accelerometers. Data corresponding to sensor signals from knock sensors 80K, 82K, 84K, and 86K may be sent to ignition control unit 130 by ECM 110. Alternatively, signals from knock sensors 80K, 82K, 84K, and 86K may be provided to ignition control unit 130. Knock sensors may also be provided in the manifolds to sense knock.

ECM 110 may count instances of knock in a particular cylinder and may count such instances beginning after completion of a cylinder regeneration event. Further, ECM 110 may determine that cylinder regeneration is desirable once the knock frequency for a particular D-EGR cylinder exceeds a knock frequency threshold. The knock frequency may be indicative of carbon build-up and the knock frequency threshold may be set to trigger cylinder regeneration once the knock frequency, determined over a predetermined time duration, exceeds the knock frequency threshold.

Combustion engine 10 further comprises (not shown) a fuel supply system configured to supply fuel to fuel injectors 70, 72, 74, and 76. ECM 110 may then individually control the fuel supplied to each combustion cylinder based on a desired AFR for each combustion cylinder. The ignition energy for each combustion cylinder may be based on the desired AFR, an EGR fraction, a mode of operation of the engine, a type of air-charger, and any other characteristic and desired performance of the combustion engine. In some embodiments, a controller may determine that the effectiveness of one of the D-EGR cylinders may improve by regenerating the cylinder, and may effect the ignition energy for such D-EGR cylinder to cause said cylinder regeneration event. The AFR, EGR fraction, ignition event timing, intake manifold temperature (IMT), quantity of fuel injected, compression ratio, and other operating characteristics may be altered to regenerate the cylinder. In one example, the compression ratio is varied via variable valve management, whereby the timing of the intake valve closing event is adjusted to increase the compression ratio.

In various embodiments, a controller may determine that the effectiveness of a D-EGR cylinder may improve, or that a regeneration event is desired, based on engine run-time, duty-cycle, AFR history, fuel usage, misfire frequency, ion sensing, and any other parameter value that may indicate, alone or in combination with other parameter values, that excessive carbon build-up may be present in a D-EGR cylinder. Carbon deposits are likely present following a period of running a rich fuel mixture. A statistic representative of the AFR history may be used. For example, the average AFR for a cylinder over a predetermined time period may be lower than a threshold, indicating that regeneration may be desirable. As used herein “rich” refers to an AFR or lambda below stoichiometric. Generally, airflow might not be the same across all cylinders due to intake manifold and/or cylinder head port designs. Thus, it is advantageous to consider the operating conditions of D-EGR cylinders individually as build-up and regeneration needs will vary across the cylinders.

In some embodiments, a method of determining the need to regenerate a cylinder comprises determining the AFR of the cylinder over time, developing a build-up parameter based on the AFR of the cylinder determined over time, comparing the build-up parameter to a threshold, and determining that the cylinder should be regenerated if the build-up parameter satisfies the threshold. As is known, AFR represents a ratio of the mass of air to the mass of fuel and the air-fuel equivalence ratio, lambda, is the ratio of the actual AFR to stoichiometric AFR for a given mixture, which accounts for fuel differences. Thus a build-up parameter based on the AFR may comprise a parameter based on lambda. In some examples, the build-up parameter is a function of the hours of operation of the D-EGR cylinder and lambda being≦a build-up threshold corresponding to conditions that begin to build up carbon. The build-up threshold could be 1.0 or less and could be set experientially to reflect a build-up level at which regeneration is desirable. The build-up parameter is configured to trigger regeneration sooner if the AFR is richer or is rich for a longer period of time.

In one example of the present embodiment, the build-up parameter is determined by dividing the amount of time the D-EGR cylinder operated since the last regeneration event by the average lambda while lambda≦build-up threshold. Thus if the build-up threshold is 1.0, the hours during which the D-EGR cylinder has lambda>1.0 are not included in the average. A timer could be reset after the regeneration event and enabled anytime the condition lambda≦build-up threshold occurs. The lambda values could be summed/added anytime the condition lambda≦build-up threshold occurs and then averaged. The average would decrease as combustion becomes richer. The parameter could have the form [time]/[average lambda] to reflect that carbon will build up as a function of time and the inverse of lambda, in which case a build-up parameter that is equal to or exceeds the threshold satisfies the threshold, To illustrate the present example, the threshold could 1,000 and thus would be satisfied if hours/average lambda meet or exceed 1,000. The threshold would thus be satisfied if (always calculated in response to lambda being below the lambda threshold):
(a) hours=1,000, build-up threshold=1.0, and lambda=1.0 for the 1,000 hours;
(b) hours=900 and average lambda≦0.9;
(c) hours=800 and average lambda≦0.8.

If the actual AFR is used instead of lambda, then the build-up threshold must relate to the type of fuel used, Generally, the stoichiometric AFR for a gasoline engine is about 14.7:1, with larger ratios denoting lean mixtures and smaller ratios denoting rich mixtures. In one example, the build-up threshold is about 12, corresponding to a lambda of 0.8 in a gasoline engine. Of course the invention is not limited to gasoline engines and is equally applicable to diesel and mixed or dual-fuel engines.

After determining that the cylinder should be regenerated, a method of operating a D-EGR cylinder comprises regenerating the D-EGR cylinder. In one variation, regenerating the D-EGR cylinder comprises raising a temperature of the D-EGR cylinder sufficiently to burn-off at least some carbon built up in the D-EGR cylinder. In one example, the method comprises raising the temperature above a regeneration temperature, wherein the regeneration temperature is sufficient to burn-off at least some carbon, for a predetermined time. In one example, the engine may be a gasoline engine, the regeneration temperature may be a temperature above 180 degrees, the predetermined time may be 30 seconds. In one example, the engine may be a gasoline engine, the regeneration temperature may be a temperature above 220 degrees, and the predetermined time may be less than 30 seconds.

After determining that the cylinder should be regenerated, a method of operating a D-EGR cylinder may comprise regenerating the D-EGR cylinder and concurrently operating another D-EGR cylinder under conditions configured to compensate for said regeneration. In some examples, the operating conditions of the non-regenerating D-EGR cylinders are configured to reduce the temperatures of gases generated by those cylinders. The temperatures may be reduced to maintain an average temperature of the combined gases during the regeneration event about equal to the average of the temperature before the regeneration event. The temperatures may also be reduced to maintain an average temperature of the combined gases during the regeneration event equal to or below a desired temperature. In one example, the temperatures of the gases produced by the non-regenerating D-EGR cylinders are reduced by advancing the spark timing of the non-regenerating D-EGR cylinders. In another example, the temperatures of the gases produced by the non-regenerating D-EGR cylinders are reduced by increasing the AFR of the non-regenerating D-EGR cylinders. In a further example, the temperatures of the gases produced by the non-regenerating D-EGR cylinders are reduced by changing valve timing to trap less air in the non-regenerating D-EGR cylinders, thus reducing the amount of work by the cylinder and correspondingly reducing the combustion temperature.

In some embodiments, regenerating the D-EGR may comprise reducing a cylinder piston cooling nozzle (PCN) flow to elevate the temperatures of the piston crown and the combustion chamber. Elevated temperatures may burn-off carbon deposits.

In some embodiments, regenerating the D-EGR may comprise inducing combustion knock to separate carbon deposits from components including valves, pistons, and cylindrical surfaces. Combustion knock may be induced, for example, by delaying spark ignition and/or operating the combustion cylinder with a rich AFR. Knock may be induced after a period of load or advanced ignition timing, for example. Knock produces pressure waves in the cylinder that may loosen or separate the carbon deposits and thus enable discharge of the deposits from the cylinder.

In some embodiments, regeneration is achieved by advancing spark timing, increasing IMT, increasing AFR, reducing EGR fraction, increasing fuel injection quantity, and increasing the compression ratio, or any combination of the foregoing operating parameter alterations relative to the values of the operating parameters when regeneration is not desired. In some embodiments, the operating characteristics of the remaining D-EGR cylinders may be altered to maintain a desired EGR performance of the combustion engine.

In some embodiments, the combustion engine comprises a bypass valve between the exhaust manifold of the D-EGR cylinder and an exhaust conduit downstream of the turbocharger to prevent at least some of the fouled gases resulting from regeneration from flowing through the EGR cooler.

FIG. 2 is a circuit/block diagram of an embodiment of a circuit configured to provide ignition energy to an ignition aid plug. As shown therein, ECM 110 provides ignition energy control signals 120 to ICU 130. In turn, ICU 130 generates switching control signals 232 from ignition energy control signals 120, which are provided to operate a switch 252 in a switching circuit 200 powered by a power supply 202, Energy from power supply 202 passes through a diode D1 to charge a capacitor C1, Activation of switch 252 by ICU 130 causes switch 252 to close, enabling the charge in capacitor C1 to induce power in the secondary winding of a transformer T1 which is coupled to, in this example, ignition aid plug 80. Switching circuit 200 enables generation of higher voltages and currents in the ignition aid plugs than is available from power supply 202, thus enabling higher magnitude of the ignition energy provided to ignition aid plug 80. The voltage, current, and duration of the ignition energy provided by switching circuit 200 may be controlled during each ignition event. A plurality of ignition energy pulses may be provided, each pulse having different voltage, current, and duration characteristics, A combination of pulses may be provided to generate individualized ignition energy functions during ignition events.

FIG. 3 is a block diagram of an embodiment of ECM 110. The embodiment of ECM 110 disclosed herein may be utilized by combustion engine 10 and may operate in conjunction with IGU 130 as disclosed in FIG. 2. ECM 110 comprises an operating conditions determining module 310 structured to determine operating conditions 312 of a combustion engine using sensor signals, the combustion engine including at least one D-EGR cylinder, a ND-EGR cylinder, and ignition aid plugs configured to aid ignition in the at least one D-EGR cylinder and the ND-EGR cylinder. ECM 110 further comprises an ignition energy characteristics setting module 320 structured to set ignition energy characteristics 322, 324 for the D-EGR cylinder and the ND-EGR cylinder based on operating conditions 312. As used herein, ignition characteristics 322, 324 include any characteristics of ignition energy except ignition timing. Ignition timing may be determined by an ignition timing module 340, as described below. Ignition energy characteristics 322, 324 include at least one of magnitude of energy, current, voltage, and ignition energy duration. Ignition energy characteristics 322, 324 may include intra-event timing characteristics, for example timing between voltage pulses within an ignition event, but such timing characteristics do not include ignition timing, which as described below refers to the timing of ignition events and not to timing within events, At least one characteristic of ignition energy characteristics 324 for the ND-EGR cylinder is different than a corresponding ignition energy characteristic 322 for the D-EGR cylinder. ECM 110 further comprises a communication module 330 structured to transmit ignition control signals 120 to ignition control unit 130. Ignition control signals 120 are based on ignition energy characteristics 322, 324 set by ignition energy setting module 320.

In a variation of the present embodiment, engine control module 110 further comprises an ignition timing module 340 structured to set ignition timing for the at least one D-EGR cylinder and the ND-EGR cylinder. Ignition timing refers to the timing of ignition of each cylinder relative to a master timing event, such as a degree of rotation of a camshaft of the combustion engine. Generally, each cylinder is timed so that ignition events are evenly distributed over a rotation or two of the camshaft. However, timing for each cylinder may be varied by a degree or more, or a fraction thereof, based on the operating conditions and combustion engine configuration, for example to balance the torque generated by the cylinders and applied to a crankshaft of the combustion engine. Ignition events may include a main ignition event and pre and post ignition events occurring before and after, respectively, the main ignition event.

In a variation of the present embodiment, engine control module 110 further comprises an AFR setting module 350 structured to set a first target AFR 352 for the dedicated EGR cylinder. Ignition energy characteristics setting module 350 is further structured to set ignition energy characteristics 322 for the dedicated EGR cylinder based on first target AFR 352, in addition to other operating characteristics.

In one example of the present variation, the at least one dedicated EGR cylinder comprises two dedicated EGR cylinders, and AFR setting module 350 is further structured to set a second target AFR. Ignition energy characteristics setting module 320 is further structured to set ignition energy characteristics 322 for the second dedicated EGR cylinder based on the second target AFR. Advantageously, two dedicated EGR cylinders provide the capability to control the overall amount of exhaust gas recirculation while also improving efficacy of the dedicated EGR cylinder components. In a further example, the first target AFR is richer than the second target AFR during a first time period, and the second target AFR is richer than the first target AFR during a second time period. Running lean can clean the combustion cylinder, ignition aid plug, piston, and fuel injector valves by removing carbon build-up, thus increasing their effectiveness. Alternating the AFRs during the first and second time periods enables cleaning of one dedicated EGR cylinder while maintaining an overall AFR for the pair, and then cleaning the other dedicated EGR cylinder. The duration of the first and second periods may be determined experientially. Of course, there may be a third period during which both dedicated EGR cylinders run rich, stoichiometric, or lean. For instance, both dedicated EGR cylinders may run rich when the combustion engine is started, In yet another example, AFR setting module 350 is further structured to set a stoichiometric AFR for the non-dedicated EGR cylinder, and ignition energy characteristics setting module 320 is further structured to set ignition energy characteristics 324 for the non-dedicated EGR cylinder based the stoichiometric AFR.

In another variation of the present embodiment, ECM 110 further comprises an EGR fraction setting module 370 structured to set a first target EGR fraction 372 and determine an EGR fraction. The EGR fraction may be determined based on sensed values obtained from the sensors as described generally above. For example, one or more oxygen sensors such as 30O, 40O, or 50O may be used to determine the EGR fraction in any manner known the art. Ignition energy characteristics setting module 320 is further structured to set ignition energy characteristics 322, 324 for the dedicated EGR cylinder based on a difference between first target EGR fraction 372 and the determined EGR fraction. EGR fraction setting module 370 may receive first target AFR 352 and set first target EGR fraction 372 based thereon.

In a yet further variation of the present embodiment, ignition energy characteristics setting module 320 is further structured to vary ignition energy characteristics 322, 324 to deactivate the ignition aid plug of the non-dedicated EGR cylinder in a start mode and to activate the ignition aid plug of the non-dedicated EGR cylinder in a run mode. In this manner, ignition energy characteristics setting module 320 can delay ignition in the non-dedicated EGR cylinders until they reach a predetermined temperature or desired recirculated/fresh gas mix, for example. In another example, one or more of the sensors are structured to sense a characteristic indicative of an amount of recirculated exhaust gas, and ignition energy characteristics setting module 320 is further structured to switch from the start mode to the run mode responsive to the amount of recirculated exhaust gas exceeding a predetermined amount. The amount of recirculated exhaust gas may be determined based on signals from sensors located in a path between block 40 and intake manifold 30, such as 40O, 62F, 22F, and 30O. Ignition energy characteristics may also be varied during or following a shutdown of the combustion engine so as to enhance EGR scavenging.

In variations of the present embodiment, ECM 110 comprises EGR fraction setting module 370 and AFR setting module 350. EGR fraction setting module 370 and AFR setting module 350 cooperate to establish desired AFRs for the dedicated and non-dedicated EGR cylinders, may establish different AFRs for each dedicated EGR cylinder as described above, and may establish ignition energy characteristics for each cylinder based on the EGR fraction and corresponding AFRs for each cylinder. In some embodiment, EGR fraction is used to determine if regeneration is desired. Simultaneously EGR temperature is monitored as it affects intake manifold temperature which impact engine efficiency and NOx emissions, EGR pressure is maintained at a level that is sufficiently high to insure proper EGR flow relative to the compressor-out and/or intake manifold pressures.

The configuration shown in FIG. 1 thus allows for ECM 110 to adjust one or more ignition energy characteristics 322, 324 to be used for controlling one or more combustion cylinders 42, 44, 46, and 48 in response to one or more engine operating conditions. For example, an EGR fraction and an EGR quality metric are engine operating conditions that may be ascertained based on the oxygen sensor 40O and EGR flow rate sensor 62F, among other sensors distributed in combustion engine 10. By further way of illustration, the in-cylinder pressure is an engine operating condition that may be detected based on in-cylinder pressure sensors 80P, 82P, 84P, and 86P. Likewise, the knock detection metric is an engine operating condition that may be determined from knock detection sensors 80K, 82K, 84K, and 86K.

In some embodiments, ECM 110 can, based on the temperature, pressure, and flow rate sensors described above, determine other engine operating conditions. For example, from the information gleaned from the in-cylinder pressure sensors 80P, 82P, 84P, and 86P and additional data inputs, ECM 110 can determine an in-cylinder temperature. In this manner, ECM 110 can account for engine operating conditions including an AFR, a misfire detection, a cylinder balancing determination, a charge flow, an intake air temperature, a determination based on transient conditions that may be determined based on any combination of sensed values and/or estimated values.

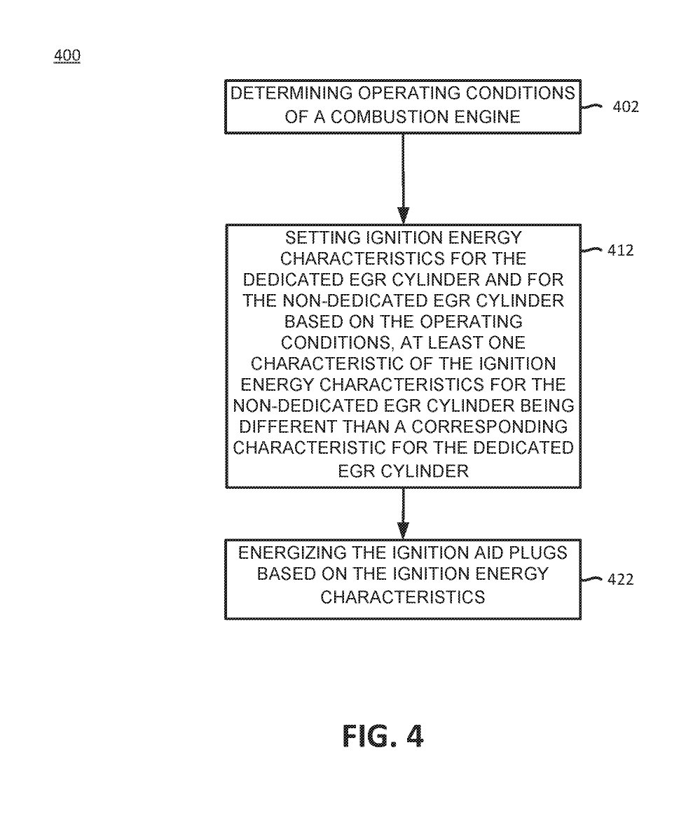

FIG. 4 depicts a flowchart 400 of a method for energy ignition management. The method may be implemented by ECM 110 in combustion engine 10. The method begins at 402, with determining operating conditions of a combustion engine including at least one dedicated EGR cylinder, a non-dedicated EGR cylinder, and ignition aid plugs configured to aid ignition in the at least one dedicated EGR cylinder and the non-dedicated EGR cylinder. As discussed above, ignition aid plugs include spark-plugs and glow-plugs.

The method continues at 412, with setting ignition energy characteristics for the dedicated EGR cylinder and for the non-dedicated EGR cylinder based on the operating conditions. The ignition energy characteristics including at least one of magnitude of energy, current, voltage, and ignition energy duration. The ignition energy characteristics do not include ignition timing. At least one characteristic of the ignition energy characteristics for the non-dedicated EGR cylinder is different than a corresponding characteristic for the dedicated EGR cylinder. For example, the amount of ignition energy may differ, or the energy may be the same but may be distributed over a different duration or in a different timing pattern. In a variation of the present embodiment, the method further comprises setting ignition timing characteristics. Ignition timing characteristics may be based on the position of the camshaft or any other indication of the timing of the engine. The ignition timing for each cylinder, dedicated and non-dedicated, may also be determined based on the operating conditions of the engine, although not necessarily the conditions used to determine ignition energy characteristics.

The present embodiment of the method continues at 422, with energizing the ignition aid plugs based on the ignition energy characteristics. The ignition energy characteristics for the non-dedicated EGR cylinder may also be applied to all the non-dedicated EGR cylinders.

In variations of the present embodiment, the method further comprises setting a first target AFR for the dedicated EGR cylinder; and setting the ignition energy characteristics for the dedicated EGR cylinder based on the first target AFR.

In variations of the present embodiment, the at least one dedicated EGR cylinder comprises two dedicated EGR cylinders, and the method further comprises setting a second target AFR; setting ignition energy characteristics for the second dedicated EGR cylinder based on the second target AFR; energizing the ignition aid plug of one of the two dedicated EGR cylinders based on the ignition energy characteristics for the first dedicated EGR cylinder; and energizing the ignition aid plug of the other of the two dedicated EGR cylinders based on the ignition energy characteristics for the second dedicated EGR cylinder. In one example, the first target AFR is richer than the second target AFR during a first time period, and the second target AFR is richer than the first target AFR during a second time period. For example, the first target AFR may be rich during the first time period and lean during the second time period. The first and second time periods may be sufficient to clean the particular cylinder and fuel injector by running the cylinder lean. While the duration may vary from engine to engine, the determination that the cylinder and fuel injector are cleaned is determinable based on the operation conditions. For example, oxygen and knock sensors may be monitored to determine a change in the combustion of the cylinders, the change being indicative of improved combustion.

In a further example, the method comprises setting a stoichiometric AFR for the non-dedicated EGR cylinder; and setting the ignition energy characteristics for the non-dedicated EGR cylinder based on the stoichiometric AFR. Thus, in combination with the preceding examples, dedicated EGR cylinders may run rich or lean while the non-dedicated EGR cylinders run stoichiometrically. Of course, dedicated EGR cylinders may also run stoichiometrically between the first and second time periods.

In variations of the present embodiment, the method further comprises setting a first target EGR fraction; and setting the ignition energy characteristics for the dedicated EGR cylinder based on a difference between the first target EGR fraction and a determined EGR fraction. A dedicated EGR cyclinder can produce a maximum amount of exhaust gas that is regenerated through all the cylinders. The composition of the exhaust gas determines the EGR fraction. Once the ECU determines a desired EGR fraction, the ignition energy characteristics for the ignition aid plug of the cylinder can be varied in a feedback loop based on the error between the first target EGR fraction and the determined EGR fraction, which may be determined based on sensor signals as described above.

In variations of the present embodiment, the method further comprises varying the ignition energy characteristics in response to a combustion engine load change. As is known in the art, a combustion engine coupled to a transmission may be mapped to tailor its torque output to the characteristics of the transmission and desired performance. As the load on the engine changes, the engine mapping may be used to determine desired ignition characteristics, and the ignition energy characteristics may be adapted accordingly to produce the desired ignition characteristics and resulting torque output. In one example, varying the ignition energy characteristics comprises deactivating the ignition aid plug for the non-dedicated EGR cylinder in a start mode and activating the ignition aid plug for the non-dedicated EGR cylinder in a run mode. Further, the dedicated EGR cylinders may be run rich in the start mode to increase the EGR fraction. This may be done to more rapidly heat the non-dedicated EGR cylinder during a start mode. As the cylinders warm up, ignition characteristics change, and the EGR fraction may change, thus the ignition energy characteristics may be used to refine operation of the combustion engine. The start mode may last a second or longer, depending engine temperature, compression ratios etc. In a further example, varying the ignition energy characteristics further comprises switching from the start mode to the run mode responsive to a predetermined amount of recirculated exhaust gas. The predetermined amount of recirculated exhaust gas may be predetermined based on nominal operating conditions, which may also be used to set the duration of the start mode for different conditions. A table may be used to correlate operating conditions to start mode duration. Thus, the predetermined amount of recirculated exhaust gas is not necessarily a set amount, but can be an amount set for each of a plurality of sets of operating conditions.

The ignition energy may be varied based also on the regions of the EGR map. At low load, it is desirable to run lean to reduce the EGR fraction. As load increases, the AFR also increases so the ignition energy may be adjusted accordingly. The ignition energy may also be adjusted based on the type of catalyst used by the regeneration system, and the desired temperature for the catalyst at different points in time.

In variations of the present embodiment, the method further comprises varying the ignition energy characteristics for the dedicated EGR cylinder based on a type of turbocharger or air-charger of the combustion engine. The type of air-charger can affect the temperature and pressure of the charged air and thus affect the ignition characteristics, The performance of the cylinders for a given type of air-charger can also be mapped so that ignition engine characteristics can be tailored to the performance of the air-charger. Exemplary air-chargers include wastegate, asymmetric turbine housing, and variable geometry turbochargers.

A method, controller, and combustion engine including said controller and configured to implement said method with said controller are also provided. In some embodiments, a method of operating a combustion engine comprises determining a first dedicated exhaust gas recirculation (D-EGR) cylinder parameter value of a first D-EGR cylinder parameter associated with a first D-EGR cylinder of the combustion engine; and regenerating the first D-EGR cylinder responsive to the first D-EGR cylinder parameter value satisfying a threshold. The threshold may be correlated to an undesirable amount of carbon build-up.

In some embodiments, a method of operating a combustion engine comprises determining a first D-EGR cylinder parameter value of a first D-EGR cylinder parameter associated with a first D-EGR cylinder of the combustion engine; determining that a carbon build-up level in the first D-EGR cylinder is excessive in response to the first D-EGR cylinder parameter value satisfying a threshold or that the carbon build-up level in the first D-EGR cylinder is not excessive if the first D-EGR cylinder parameter value not satisfying the threshold; and responsive to said determining that the first D-EGR cylinder parameter value satisfies said threshold, regenerating the first D-EGR cylinder to reduce the carbon build-up level in the first D-EGR cylinder. In one example, the threshold is correlated to an excessive amount of carbon build-up. In another example, the threshold is loosely correlated to an undesirable amount of carbon build-up.

In one variation of the present embodiment, said regenerating comprises operating the first D-EGR cylinder at an average temperature above 180 degrees Celsius for a predetermined time, In one example, said predetermined time is at least 30 seconds. In another example, said predetermined time is less than 30 seconds if said temperature is greater than 220 degrees Celsius. In a further example, said regenerating comprises one or more of: advancing an ignition event timing of the first D-EGR cylinder; increasing an inlet manifold temperature; decreasing an air fuel ratio of the first D-EGR cylinder; decreasing an injection fuel quantity of the first D-EGR cylinder; or increasing a compression ratio of the first D-EGR cylinder.

In a further variation of the present embodiment, said first D-EGR cylinder parameter value is based on at least one of an engine run time, a fuel usage of the first D-EGR cylinder, or an ion sensor value of the first D-EGR cylinder, In one example, wherein the threshold comprises a run-time threshold, the first D-EGR cylinder parameter value satisfies said threshold if the engine run time meets or exceeds the run-time threshold. In another example, the threshold comprises a fuel usage increase threshold, and the first D-EGR cylinder parameter value satisfies said threshold if a difference between a present fuel usage and a fuel usage after a preceding regeneration event meets or exceeds the fuel usage increase threshold. In a yet further example, the threshold comprises an ionization threshold, and the first D-EGR cylinder parameter value satisfies said threshold if an ionization parameter value of the first D-EGR cylinder is less than the ionization threshold. It should be understood from the preceding examples that when the variable is proportional to carbon build-up, the threshold is satisfied responsive to the value meeting or exceeding the threshold, and when the variable is inversely proportional to carbon build-up, the threshold is satisfied responsive to the value being less than the threshold.

In another variation of the present embodiment, the first D-EGR cylinder parameter comprises a pressure differential across a particulate filter or an exhaust pressure upstream of the particulate filter. In one example, the pressure parameter comprises the pressure differential across the particulate filter and the threshold comprises 0.5 PSI of pressure, and the first D-EGR cylinder parameter value satisfies said threshold if the pressure differential meets or exceeds the threshold.

In another variation of the present embodiment, the first D-EGR cylinder parameter is determined over a time elapsed since a preceding regeneration event of the first D-EGR cylinder. In one example, the first D-EGR cylinder parameter comprises a misfire frequency, an indication of a duty-cycle of the combustion engine, a number of cold starts of the combustion engine, and an indication of an air fuel ratio history of the first D-EGR cylinder.

In another variation of the present embodiment, responsive to said determining that the first D-EGR cylinder parameter value satisfies said threshold, the method comprises altering an operating condition of a second D-EGR cylinder to maintain an EGR parameter value of the combustion engine within a predetermined range during said regenerating of the first D-EGR cylinder. In one example, said EGR parameter value of the combustion engine comprises an EGR ratio, an EGR fraction, a D-EGR exhaust manifold pressure, an oxygen content of exhaust gases supplied to an D-EGR exhaust manifold, a mass flow value of exhaust gases supplied to the D-EGR exhaust manifold, or a D-EGR exhaust manifold temperature. EGR fraction and ratio represent the proportion of recirculated gases in relation to the total gases produced during combustion. Importantly, these parameters represent the amount of oxygen in the combustion chambers. Mass flow and oxygen sensors may be used to determine the amount of oxygen in the D-EGR cylinder and to control the composition of the recirculated gases by changing the fuel injection volume and timing, thus controlling the AFR, flame timing and other factors which control oxygen consumption during combustion in the cylinder. As used herein, the term cylinder corresponds to combustion cylinder or chamber.

In another variation of the present embodiment, the method further comprise, prior to said regenerating, determining a second D-EGR cylinder parameter value corresponding to a second D-EGR cylinder of the combustion engine, wherein said altering is configured to change the second D-EGR cylinder parameter value obtained prior to said regenerating by a predetermined amount.

In another variation of the present embodiment, said regenerating comprises inducing combustion knock in the D-EGR cylinder. Without being bound by theory, it is believed that inducing knock will cause carbon build-up to become lose and easier to burn off.

In another variation of the present embodiment, said regenerating comprises reducing a piston cooling nozzle flow to increase a temperature of the first D-EGR cylinder.

In another variation of the present embodiment, said regenerating comprises defining ignition energy characteristics that are different for the first and second D-EGR cylinders. In one example, the regenerating D-EGR cylinder ignition energy characteristics are configured to increase cylinder temperature while the non-regenerating D-EGR cylinder ignition energy characteristics are configured to reduce cylinder temperature relative to temperatures the cylinders would generate without regeneration.

In another variation of the present embodiment, said regenerating comprises opening a turbine bypass valve fluidly coupling a D-EGR exhaust manifold to an exhaust conduit positioned downstream of an air-compressor turbine to exhaust at least a portion of exhaust gases generated by said regenerating.

In some embodiments, the combustion engine controller comprises control logic; input contacts electrically coupled to the control logic and configured to receive operating condition values representative of operating conditions of the combustion engine; and output contacts electrically coupled to the control logic and configured to transmit control signals operable to control operation of the combustion engine, wherein the control logic is structured to: determine a first dedicated exhaust gas recirculation (D-EGR) cylinder parameter value of a first D-EGR cylinder parameter associated with a first D-EGR cylinder of the combustion engine; determine that a carbon build-up level in the first D-EGR cylinder is excessive if the first D-EGR cylinder parameter value satisfies a threshold or that the carbon build-up level in the first D-EGR cylinder is not excessive if the first D-EGR cylinder parameter value does not satisfy the threshold; and responsive to the first D-EGR cylinder parameter value satisfying said threshold, transmit the control signals via the output contacts to cause regeneration of the first D-EGR cylinder and reduce the carbon build-up level in the first D-EGR cylinder, The control logic may be structured to implement the method described in paragraphs [0066]-[0076].

Referring to FIG. 5, the control logic may comprise operating conditions determining module 310, described with reference to FIG. 3, structured to determine the operating conditions of the engine. The term “logic” as used herein includes software and/or firmware executing on one or more programmable processors, application-specific integrated circuits, field-programmable gate arrays, digital signal processors, hardwired logic, or combinations thereof. Therefore, in accordance with the embodiments, various logic may be implemented in any appropriate fashion and would remain in accordance with the embodiments herein disclosed. A non-transitory machine-readable medium comprising logic can additionally be considered to be embodied within any tangible form of a computer-readable carrier, such as solid-state memory, magnetic disk, and optical disk containing an appropriate set of computer instructions and data structures that would cause a processor to carry out the techniques described herein. A non-transitory computer-readable medium, or memory, may include random access memory (RAM), read-only memory (ROM), erasable programmable read-only memory (e.g., EPROM, EEPROM, or Flash memory), or any other tangible medium capable of storing information.

The operating conditions may comprise the values of the first D-EGR cylinder parameter and of the second D-EGR cylinder parameter. Engine parameters may comprise combustion cylinder temperature, pressure AFR, EGR fraction, inlet and outlet manifold temperatures, run-time since a regeneration event, fuel usage or injection per combustion cylinder, ion sensor current, knock frequency per combustion cylinder since a regeneration event in the combustion cylinder, and any other parameter previously described.

The control logic may comprise a D-EGR cylinder carbon build-up detecting module 502, which is structured to receive the values of the first D-EGR cylinder parameter and of the second D-EGR cylinder parameter from operating conditions determining module 310 and to compare such values to the threshold. The threshold which is stored therein or coded in the control logic. There may be multiple thresholds corresponding to multiple D-EGR cylinder parameters, and D-EGR cylinder carbon build-up detecting module 502 may be structured to make multiple comparisons until one of the comparisons results in a threshold being satisfied, D-EGR cylinder carbon build-up detecting module 502 may comprise tables to store the various thresholds and current values of the parameters.

The control logic may comprise a D-EGR cylinder regeneration characteristics setting module 504, which is structured to generate the control signals transmitted to various devices to cause regeneration of the D-EGR cylinder. The control signals may cause substitution of values. For example, the controller may be operating the combustion engine in accordance with various algorithms known in the art to generate control values for injection timing and amount, operation of EGR and dump valves, variable valve controls to control compression, and the like. Upon the determination by D-EGR cylinder carbon build-up detecting module 502 that regeneration is desirable, D-EGR cylinder regeneration characteristics setting module 504 replaces those values with values that cause regeneration. The set of values that cause regeneration may be programmable and stored in memory or may be determined dynamically. D-EGR cylinder regeneration characteristics setting module 504 may generate regenerating D-EGR cylinder regeneration characteristics 506 and non-regenerating D-EGR cylinder regeneration characteristics 508. Since regeneration may be performed on a cylinder by cylinder basis, one D-EGR cylinder may be referred to as the regenerating D-EGR cylinder and another as the non-regenerating D-EGR cylinder. The regenerating D-EGR cylinder regeneration characteristics and non-regenerating D-EGR cylinder regeneration characteristics are applied concurrently so that the non-regenerating D-EGR cylinder compensates for regeneration by the regenerating D-EGR cylinder, for example to maintain EGR parameters (e.g. temperature, pressure, EGR fraction etc.) within a desirable range. In one example, advancing the spark timing of the non-regenerating (e.g. second) D-EGR cylinder may lower the temperature of its exhaust gases to compensate for increased temperature generated by the regenerating D-EGR cylinder. D-EGR cylinder regeneration characteristics setting module 504 then transmits D-EGR cylinder control signals 510 to the various devices to cause regeneration. Alternatively, a separate module may be provided to transmit the control signals.

D-EGR cylinder regeneration characteristics setting module 504 may also time said regenerating to other combustion engine operating requirements. In one example, regeneration of a D-EGR cylinder is delayed to occur concurrently with exhaust regeneration. Since exhaust regeneration may require elevation of the exhaust gases, D-EGR cylinder regeneration can assist by raising the temperature of the exhaust gases, particularly if a bypass valve is used to divert a portion of the D-EGR cylinder gases to the exhaust. Multiple thresholds may also be used for each parameter, to distinguish build-up levels e.g. ready to regenerate, regeneration is desirable, build-up is excessive, and the like. Applying these thresholds D-EGR cylinder regeneration characteristics setting module 504 may time regeneration to engine events, such as when the engine is operating at heavy or light duty, idling, operating under cold conditions, etc. For example, if the engine is operating in cold conditions, raising the temperature of the cylinder for regeneration purposes may advantageously increase the temperature of the engine block more rapidly, achieving a synergistic effect. Accordingly, a lower threshold may be used under cold conditions while a higher threshold may be used when engine conditions indicate that regeneration

One of skill in the art, having the benefit of the disclosures herein, will recognize that the processing subsystem 100 and the ECM 110 are structured to perform operations that improve various technologies and provide improvements in various technological fields. Without limitation, example and non-limiting technology improvements include improvements in combustion performance of internal combustion engines, improvements in emissions performance, after-treatment system regeneration, engine torque generation and torque control, engine fuel economy performance, improved durability of exhaust system components for internal combustion engines, and engine noise and vibration control. Without limitation, example and non-limiting technological fields that are improved include the technological fields of internal combustion engines, fuel systems therefore, after-treatment systems therefore, air handling devices therefore, and intake and exhaust devices therefore.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

The term “about” as used herein when referring to a measurable value such as an amount, a temporal duration, and the like, is meant to encompass the exact numerical value as though it had been recited without the term “about”.

The term “comprises,” “comprising,” “containing,” and “having” and the like mean includes,” “including,” and the like, are open ended terms.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

Except where a contrary intent is expressly stated, terms are used in their singular form for clarity and are intended to include their plural form.

Occurrences of the phrase “in one embodiment,” or “in one aspect,” herein do not necessarily all refer to the same embodiment or aspect.

While this specification contains specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be depicted in a particular order, this should not be understood as requiring that such operations be performed in the particular order shown or in sequential order, or that all operations be performed, to achieve desirable results. Moreover, the separation of various aspects of the implementations described above should not be understood as requiring such separation in all implementations, and it should be understood that the described methods can generally be integrated in a single application or integrated across multiple applications.

What is claimed is:

1. A method of operating a combustion engine, the method comprising:
determining a first dedicated exhaust gas recirculation (D-EGR) cylinder parameter value of a first D-EGR cylinder parameter associated with a first D-EGR cylinder of the combustion engine; and
responsive to the first D-EGR cylinder parameter value satisfying a threshold indicative of a carbon build-up level, regenerating the first D-EGR cylinder.

2. The method of claim 1, wherein said regenerating comprises operating the first D-EGR cylinder at a temperature above 180 degrees Celsius for a predetermined time.

3. The method of claim 2, wherein said predetermined time is at least 30 seconds.

4. The method of claim 2, wherein said predetermined time is less than 30 seconds if said temperature is greater than 220 degrees Celsius.

5. The method of claim 2, wherein said regenerating comprises one or more of:
advancing an ignition event timing of the first D-EGR cylinder;
increasing an inlet manifold temperature;
increasing an air fuel ratio of the first D-EGR cylinder;
decreasing an injection fuel quantity of the first D-EGR cylinder; or
increasing a compression ratio of the first D-EGR cyclinder.

6. The method of claim 1, wherein said first D-EGR cylinder parameter value is based on at least one of an engine run time, a fuel usage of the first D-EGR cylinder, or an ion sensor value of the first D-EGR cylinder.

7. The method of claim 1, wherein the first D-EGR cylinder parameter comprises a pressure differential across a particulate filter or an exhaust pressure upstream of the particulate filter.

8. The method of claim 7, wherein the pressure parameter comprises the pressure differential across the particulate filter and the threshold comprises 0.5 PSI of pressure, and wherein the first D-EGR cylinder parameter value satisfies said threshold if the pressure differential meets or exceeds the threshold.

9. The method of claim 1, wherein the first D-EGR cylinder parameter value is determined over a time elapsed since a preceding regeneration event of the first D-EGR cylinder.

10. The method of claim 9, wherein the first D-EGR cylinder parameter comprises a misfire frequency, an indication of a duty-cycle of the combustion engine, a number of cold starts of the combustion engine, and an indication of an air fuel ratio history of the first D-EGR cylinder.

11. The method of claim 1, wherein the first D-EGR cylinder parameter value comprises an elapsed time elapsed since a preceding regeneration event divided by an average air fuel ratio (AFR) or lambda, and the first D-EGR cylinder parameter value satisfies the threshold if the first D-EGR cylinder parameter value meets or exceeds the threshold.

12. The method of claim 11, wherein the elapsed time does not include time during which the average AFR or lambda is greater than the threshold.

13. The method of claim 1, further comprising, responsive to said determining that the first D-EGR cylinder parameter value satisfies said threshold, altering an operating condition of a second D-EGR cylinder to maintain an exhaust gas recirculation (EGR) parameter value of the combustion engine within a predetermined range during said regenerating of the first D-EGR cylinder.

14. The method of claim 13, wherein said EGR parameter value of the combustion engine comprises an EGR fraction, a D-EGR exhaust manifold pressure, an oxygen content of exhaust gases supplied to an D-EGR exhaust manifold, a mass flow value of exhaust gases supplied to the D-EGR exhaust manifold, or a D-EGR exhaust manifold temperature.

15. The method of claim 1, further comprising, prior to said regenerating, determining a second D-EGR cylinder parameter value corresponding to a second D-EGR cylinder of the combustion engine, wherein said altering is configured to change the second D-EGR cylinder parameter value obtained prior to said regenerating by a predetermined amount.

16. The method of claim 1, wherein said regenerating comprises inducing combustion knock in the D-EGR cylinder.

17. The method of claim 1, wherein said regenerating comprises reducing a piston cooling nozzle flow to increase a temperature of the first D-EGR cylinder.

18. The method of claim 1, further comprising opening a turbine bypass valve fluidly coupling a D-EGR exhaust manifold to an exhaust conduit positioned downstream of an air-compressor turbine to exhaust at least a portion of exhaust gases generated by said regenerating.

19. The method of claim 1, wherein regenerating the first D-EGR cylinder comprises operating the first D-EGR cylinder with a first air fuel ratio (AFR) and operating a second D-EGR cylinder with a second AFR richer than the first AFR for a first time period, and subsequently, operating the first D-EGR cylinder with a third AFR and operating the second D-EGR cylinder with a fourth AFR leaner than the third AFR, during a second time period.

20. A combustion engine controller comprising:
control logic:
input contacts electrically coupled to the control logic and configured to receive operating condition values representative of operating conditions of the combustion engine; and
output contacts electrically coupled to the control logic and configured to transmit control signals operable to control operation of the combustion engine,
wherein the control logic is structured to:
determine a first dedicated exhaust gas recirculation (D-EGR) cylinder parameter value of a first D-EGR cylinder parameter associated with a first D-EGR cylinder of the combustion engine; and
responsive to the first D-EGR cylinder parameter value satisfying a threshold, transmit the control signals via the output contacts to cause regeneration of the first D-EGR cylinder.

21. A combustion engine comprising the engine controller of claim 20.
